(19) United States
(12) Patent Application Publication
(10) Pub. No.: US 2009/0108056 A1
(43) Pub. Date: Apr. 30, 2009

(54) Electronic Bar Code Device and Methods for Using Same

(75) Inventors: Michael K. Faust, Upper Saddle River, NJ (US); Michael Kroha, Sandy Hook, CT (US)

Correspondence Address: KALOW & SPRINGUT LLP, 488 MADISON AVENUE, 19TH FLOOR, NEW YORK, NY, 10022, US

(73) Assignee: IPOCUS LLC, Mahwah, NJ (US)

(21) Appl. No.: 12/245,202

(22) Filed: Oct. 3, 2008

Related U.S. Application Data
(60) Provisional application No. 61/050,720, filed on May 6, 2008.
(60) Provisional application No. 61/012,970, filed on Dec. 12, 2007.
(60) Provisional application No. 60/982,854, filed on Oct. 26, 2007.

(51) Int. Cl. G06F 17/00; G06K 19/06

(52) U.S. Cl. 235/375; 235/494

(57) ABSTRACT

Consumers and patrons of service establishments often carry a plurality of plastic cards with bar codes affixed to them. Devices and methods are provided that permit a user to carry one device rather than a plurality of cards, and for business to capitalize on the ease with which these devices may be used.

### CROSS-REFERENCE TO RELATED APPLICATIONS

This application claims the benefit of U.S. Provisional Application No. 61/050,720, filed May 6, 2008, U.S. Provisional Application No. 61/012,970, filed Dec. 12, 2007 and U.S. Provisional Application No. 60/982,854, filed Oct. 26, 2007. The entire disclosure of those applications is incorporated by reference as if set for fully herein.

### FIELD OF THE INVENTION

The present invention relates to the field of portable electronic bar code devices.

### BACKGROUND OF THE INVENTION

Many consumers walk around with one or more plastic cards that have bar codes affixed to them. These bar codes may represent consumer identification numbers that are associated with particular persons or families and that are issued by retail stores or service providers.

By way of example, retailers such as supermarkets, pharmacies and bookstores often issue these cards to consumers with the lure of discounts when consumers use them. When making a transaction at one of these stores, either prior to or after presenting an item to be purchased to a cashier and prior to paying for the item, a consumer will present the card, which can be read by a bar code reader. When a consumer presents the card, one of four types of bar code readers is typically used to detect the consumer identification number: pen type readers (e.g. bar code wands), laser scanners, CCD readers and camera-based readers.

At the vendor, the device that reads the bar code, (the bar code reader) is in communication with a computer processor. The computer processor may access the user's account if appropriately instructed and save a description of the purchases to a consumer's specific file. The computer processor may also apply a discount to that consumer's purchase, for example, charging reduced prices for certain items and/or applying a certain percentage savings to all items. This reduced price may be awarded based on the mere presentation of a card to the vendor or based on the accumulation of a threshold of prior purchases, i.e., a rewards program.

Because in many cases the cards are free, consumers are typically eager to acquire them. Further, even if the cards are not free and a retailer charges a fee, e.g., a yearly fee, the consumer may receive additional discounts that more than outweigh the cost of the card.

These cards are attractive to the retailer for at least three reasons: (1) the cards instill customer loyalty because customers perceive that they are obtaining a bargain; (2) the retailer can track its customers' spending patterns, and in turn be able to target individual customers with special promotions or coupons, as well as track spending trends throughout a store and across franchises; and (3) the retailer can avoid the hassle of issuing and collecting its own paper coupons.

Because the bar codes are representations of consumer identification numbers, the plastic cards that carry them also typically list the digits of the codes that they represent. If a consumer of a particular establishment transacts business on the Internet, she can use the same code by inputting her specific digits on-line if that retailer's e-commerce branch is configured to accept it.

Other types of businesses also issue plastic cards with bar codes to their patrons. For example, health clubs issue them. When the user of a health club checks in, she may present the card at the front desk to a bar code reader. The bar code reader may be in communication with a computer processor, which accesses a file associated with the bar code. From within the file, a user profile including with a picture of the patron may be pulled up and displayed on a screen to an employee of the health club. The employee may then easily verify that the person presenting the card is the person with whose account the card is associated.

The cards that contain the bar codes are typically comprised of plastic and are approximately the same size as a credit card or are of a sufficiently small size to fit on a key ring. Unfortunately, the number of establishments that issue these types of cards has grown exponentially in recent years. Thus, any one consumer may have dozens of these types of cards and be forced to fumble through a stack of them when trying to present a particular card at any one establishment.

Because of the limits of known technologies and methodologies, there remains an unmet need for retail and service businesses to be able to satisfy consumers' desires to save money and/or quickly present identification without being encumbered by an undesirable number of different bar code containing cards. The present invention addresses those needs.

### SUMMARY OF THE INVENTION

The present invention is directed to a device that displays a bar code, methods for using the device, methods for populating the device, and systems that permit the use of the device.

According to one embodiment, the present invention is directed to an electronic device for displaying a tracking code. The device comprises: (a) a display means; (b) a computer program product, wherein the computer program product comprises an executable set of commands that enable a user (i) to select a tracking code and (ii) to display the tracking code within the display means in a plurality of bar code formats; and (c) a memory module, wherein the memory module is configured to store a plurality of tracking codes and is operably coupled to the computer program product. The tracking code is a code that may be represented by an image that is, for example, in the form of the aforementioned bar code, and also may be represented by numeric, alphabetic or alphanumeric digits or characters.

According to a second embodiment, the present invention is directed to a method of accessing an electronic tracking code for display and detection. The method comprises: (a) activating a device, wherein the device comprises (i) a display means, (ii) a computer program product, wherein the computer program product comprises an executable set of commands that enable a user (1) to select a tracking code and (2) to display the tracking code within the display means, and (iii) a memory module, wherein the memory module is configured to store a set of a plurality of tracking codes, (b) selecting a tracking code from within the set of the plurality of electronic tracking codes thereby causing the tracking code that has been selected to be displayed; and (c) presenting the device to a detection apparatus and displaying in a plurality of bar code formats the tracking code that has been selected.

According to a third embodiment, the present invention is directed to a method for providing a user with a tracking code for display on a device. The method comprises saving a tracking code on a device, wherein the device comprises: (a) a display means; (b) a computer program product, wherein the computer program product comprises an executable set of commands that enable a user (i) to select a tracking code and (ii) to display the electronic tracking code within the display means; and (c) a memory module, wherein the memory module is configured to store a plurality of tracking codes. The tracking code may by way of example, be input directly by the consumer or by a commercial vendor or obtained from a web-site where a third party has made the code available for downloading.

According to a fourth embodiment, the present invention provides a method for facilitating shopping. The method comprises: (a) storing a first tracking code and a first identifier on a device, wherein the device is capable of displaying the first tracking code as a first bar code and capable of displaying the first identifier; (b) storing a second tracking code on the device, wherein the device is capable of displaying the second tracking code as a second bar code, wherein the second tracking code comprises or is associated with an expiration code, wherein the expiration code defines a period of time; and (c) selecting the first identifier, thereby causing the device to display the second bar code if the first identifier is selected within the period of time, and if the first identifier is selected outside (i.e. not within) the period of time, then displaying the first bar code.

There are many ways to denote the differences between the first and the second tracking codes. For example, the first and second tracking codes may have the same number of digits and differ with respect to a subset or all of those digits. Thus, if a first tracking code has the following eighteen digits 123456789012345600, the second tracking code may have the following eighteen digits: 123456789012345614. The last two digits of “00” may denote that the tracking code is standard and the “14” may denote a temporary sale code that is in force for fourteen days from the date of installation. Alternatively, the first and second tracking codes may be of different lengths. Thus, in this example, the first tracking code still has eighteen digits 123456789012345600, but the second tracking code may have twenty digits: 12345678901234560014. As long as the display means is configured to display the different bar codes and the reader both can read the codes and is connected to a processor that can interpret them, either methodology can be used in connection with the present invention.

According to a fifth embodiment, the present invention comprises a system for retrieving information stored within a bar code device. The system comprises: (a) an electronic bar code device; (b) an optical reader; and (c) a computer. The electronic bar code device is capable of displaying a tracking code in a plurality of bar code formats and is capable of displaying an identifier as described in connection with the other embodiments of the invention. The optical reader is operably coupled to a processor, and the optical reader is capable of reading a bar code as displayed on the device. The processor may then direct certain action with respect to the transaction, e.g., applying a discount to the price of an item. The device is also capable of interfacing with a computer and storing data provided by the computer, including the tracking code and identifier. The computer is optionally connected to the Internet. The identifier may be the descriptor of the other embodiments.

According to a sixth embodiment, the present invention is directed to a device for displaying bar codes, wherein said device comprises: (a) a plurality of bar code elements, wherein each bar code element comprises a first elongated flat face, a second elongated flat face and a third elongated flat face, wherein said first elongated flat face is colored with a first color and said second elongated flat face is colored with a second color, wherein said first color and said second color are not the same color and wherein each of said bar code elements may rotate along an elongated axis; and (b) a mechanism for controlling the position of each of said bar code elements around its axis.

Through the various embodiments of the present invention, one may easily and efficiently obtain, use and take advantage of electronic bar code technologies.

### BRIEF DESCRIPTION OF THE FIGURES

FIGS. 1A-1C are representations of an embodiment of the device of the present invention. FIG. 1A shows the device as it may be positioned in a case and attached to a key ring. FIG. 1B shows the device rotated outside of its casing to show the location of a potential USB port connection. FIG. 1C shows the device as it may be connected to a central processing unit.

FIGS. 2A and 2B are representations of a device of the present invention with the screen displaying a first set of three descriptors and a second set of three descriptors after the user has scrolled down one descriptor. FIG. 2C is a representation of a device of the present invention with the screen displaying a bar code.

FIG. 3 is a representation of the functional units of a device of the present invention.

FIG. 4 is a representation of a flowchart that describes a method for populating the dataset of a device of the present invention through a connection to the Internet.

FIG. 5 is a representation of an electronic device as connected to a standalone data input station.

FIG. 6 is a representation of a flowchart that describes a method for populating the dataset of the present invention through a standalone device.

FIGS. 7A, 7B, 7C and 7D are representations of a method of displaying a bar code according to the present invention.

### DETAILED DESCRIPTION OF THE INVENTION

Unless otherwise specified, any of the features of the various embodiments described herein can be used in conjunction with features described in connection with any other embodiments disclosed. Accordingly, features described in connection with the various or specific embodiments are not to be construed as not suitable in connection with other embodiments disclosed herein unless such exclusivity is explicitly stated or implicit from the context.

### DEFINITIONS

Unless otherwise specified or apparent from context, the terms and phrases described below have the following specified meanings.

The term “consumer” refers to an individual who visits a store and shops for or looks at items within a store or patronizes a service establishment. An individual is a consumer regardless of whether she actually purchases an item and regardless of whether she enters the store with the intention of browsing or actually making a purchase. A consumer can use a tracking code in a physical store or on-line. The term “consumer” is used interchangeably with the term “user.”

The term “module” refers to one or more logic routines that may be stored on hardware, software or hybrids of hardware and software.

The phrase “operably coupled” means linked or associated in a manner that enables the elements to function in their designed manner. The methods of coupling may, for example, include, but are not limited to electronic circuits, hardware and/or software. Further, items may be coupled to one another directly or indirectly through a separate processor.

The phrase “tracking code” refers to a code that may be represented by a series of numbers, letters, other characters or combinations thereof, and that may be assigned to a consumer. Typically, for any given vendor or service provider, each consumer (or consumer family, e.g. all consumers within a household or other group who use the same code) has a different tracking code. The code is referred to as a tracking code regardless of whether a vendor tracks a particular purchase or use. When a tracking code is assigned to an individual or group of individuals, it may also be referred to as a “consumer identification code.”

The abbreviation “URL” refers to a uniform resource locator.

### PREFERRED EMBODIMENTS

According to a first embodiment, the present invention provides an electronic device for displaying a tracking code. The device comprises a display means, a computer program product and an electronic memory module. The terms “device” and “apparatus” may be used interchangeably.

Preferably the device is lightweight and thus portable. Accordingly, in some embodiments, the device weighs less than six ounces. In some embodiments, the device weighs less than five ounces. In some embodiments, the device weighs less than four ounces. In some embodiments, the device weighs less than three ounces. In some embodiments, the device weighs less than two ounces. In some embodiments, the device weighs less than one ounce.

Further, the device is preferably small enough to fit in one's pocket, in one's handbag or on one's keychain. In some embodiments the device is less than four inches long. In some embodiments the device is less than three inches long. In some embodiments the device is less than two-and-one-half inches long. In some embodiments the device is less than two inches long. In some embodiments the device is less than one and one-half inches long. If the device is in a protective casing the length refers to the device itself and not the device and casing combined.

In some embodiments the device is less than one and one-half inches wide. In some embodiments the device is less than one inch wide. In some embodiments the device is less than three quarters of an inch wide. In some embodiments the device is less than one-half of an inch wide.

In some embodiments the device is less than one inch thick. In some embodiments the device is less than three-quarters of an inch thick. In some embodiments the device is less than one-half of an inch thick. In some embodiments the device is less than one-quarter of an inch thick.

In some embodiments, the display means refers to a system or set of components that generate images that are displayed and are detectable by the human eye and/or an optical scanner. These display means of the devices may be made of any material that is now known or that comes to be known and that may be useful for displaying fonts or images that are formed from electronic data. The display means may generate an image that does not interfere with the detecting wave technology of the optical scanner. In some embodiments, the images operate cooperatively with the detecting wave technology of the optical scanner.

In some embodiments, the display means functions as an output user interface (e.g., a graphic user interface) and thus may be comprised of a computer display monitor, which is a piece of electrical equipment that displays viewable fonts to create images that are generated by a computer without producing a permanent record. Thus, the display means may by way of a non-limiting example, be a window or screen that generates and displays images or fonts. In some embodiments, the display means generates images or fonts within the visual spectrum.

In some embodiments, the display means is of sufficient size to display between one and five rows of at least twenty characters per row when the characters are of a size of not more than eighteen characters per inch. In some embodiments the display means can display between two and four rows of characters. In some embodiments, the display means can display three rows of characters.

In some embodiments, the display means may have the capability to display at least thirty characters per row. In some embodiments, the display means may have the capability to display at least forty characters per row.

In some embodiments, the display means may be configured to display fonts that are of a size of not more than sixteen characters per inch. In some embodiments, the display means may be configured to display fonts that are of a size of not more than fourteen characters per inch. In some embodiments, the display means may be configured to display fonts that are of a size of not more than twelve characters per inch.

In some embodiments, the same display means has the ability to display fonts that generate both text and bar codes. These display means may have the ability to display the text and bar code at the same time and/or at different times.

In some embodiments, there is a second display means that comprises: (a) a plurality of bar code elements, wherein each bar code element comprises a first elongated flat face, a second elongated flat face and a third elongated flat face, wherein said first elongated flat face is colored with a first color and said second elongated flat face is colored with a second color, wherein said first color and said second color are not the same color and wherein each of said bar code elements may rotate along an elongated axis; and (b) a mechanism for controlling the position each of said bar code elements around its respective axis. Preferably, these axes are parallel to each other.

The elongated flat faces are each on a side of a bar code element such that the cross section of each bar code element may be in the form of a triangle or substantially in the form of a triangle such that where any two sides meet there may be e.g., a vertex, a small rounded surface or small flattened surface. In some embodiments, the elongated sides are less than one inch long, in some embodiments, they are less than three-quarters of an inch long, in some embodiments they are less than one-half of an inch long, in some embodiments they are less than one-quarter of an inch long. The width of the side of each element may for example, be less than one-half of an inch, less than one-quarter of an inch or less than one-sixteenth of an inch.

At least two of the sides are comprised of regions of solid colors, e.g., the first elongated flat face may be black and the second elongated flat face may be white. The third elongated flat face may be another color, e.g., red, orange, yellow, green, blue, indigo or violet. A plurality of the third elongated flat faces may also each comprise part of a word or image such that when the third elongated flat faces of the bar code elements are aligned, an image is displayed. The third elongated flat face may also contain a left half that is the same color as the first elongated flat face (e.g., black) and a right half that is the same color as the second elongated flat face (e.g., white).

The regions of solid colors of the first and second sides may span the entire width and length of the respective elongated flat faces. In some embodiments, the solid colors of the first and second elongated flat faces span the entire width or substantially the entire width of the respective face and span at least 50%, at least 60%, at least 70%, at least 80%, at least 90% or at least 95% of the length of the respective face. When the first and/or second color span less than the entire length or width of the respective faces, a sufficient amount of the face, with a sufficient amount of regularity should be covered to permit the bar code reader to read any bar code that is generated using this system.

The bar code elements may be controlled by a central processing unit of a device of the present invention. Through an instruction generated by the central processing unit, a command to display the first, second or third side of each bar code element may be provided. In turn the appropriate bar code elements may be rotated to generate the correct bar code display. This mechanism may for example, be controlled through the use of the creation of small magnetic field that acts on posts that are inserted part way in the top and/or bottom of each of the bar code elements. Alternatively, there case be a single post or a plurality of posts that run through the bar code elements that are controlled by a magnetic field and/or gears. Through the ability to separately display the first and second faces, a number of different bar code patterns can be displayed. In some embodiments the third faces cannot be displayed in conjunction with any of the first or second faces.

In some embodiments, there are at least eight, at least nine, at least ten, at least eleven, at least twelve, at least thirteen, at least fourteen, at least fifteen, at least sixteen, at least seventeen, at least eighteen, at least nineteen, at least twenty bar code elements, at least twenty-one bar code elements, at least twenty-two bar code elements, at least twenty-three bar code elements or at least twenty-four bar code elements.

When the bar code is formed by the elongated faces of the preceding paragraphs, there may also be a graphic user interface as described above that is referred to as a first display means. In order to be able to instruct the central processing unit to display a particular bar code through the use of the elongated elements described above, it will be advantageous to have the first display means be separate from the second display means. This second display may be located above or below or to the side of the first display means.

Further, in some embodiments, the first display means may be on one side of the device, whereas the second display means may be located on another side, e.g., the opposite side. The first display may comprise a means for permitting review and selection of a descriptor as provided in connection with other embodiments of the present invention, and in certain of these embodiments, the descriptor that has been selected may remain displayed while the bar code is displayed on a second display means. Thus, the use of two display means is within the scope of the present invention even if both are graphic user interfaces.

If there is a separate first display means and second display means, regardless of whether the second display means is created by a graphic user interface or by the set of elongated flat face bar code elements described above, the device may be configured such that simply scrolling through the descriptors, the relevant bar codes for each descriptor is displayed. Thus, in some embodiments, particularly when there are either two graphic user interfaces (one for descriptors and one for bar codes) or one graphic user interface for descriptors and a second display of the bar code formed by the triangle elements, there is no need to have a selection mechanism that is separate from the scroll mechanism, though the inclusion of one is within the scope of the present invention.

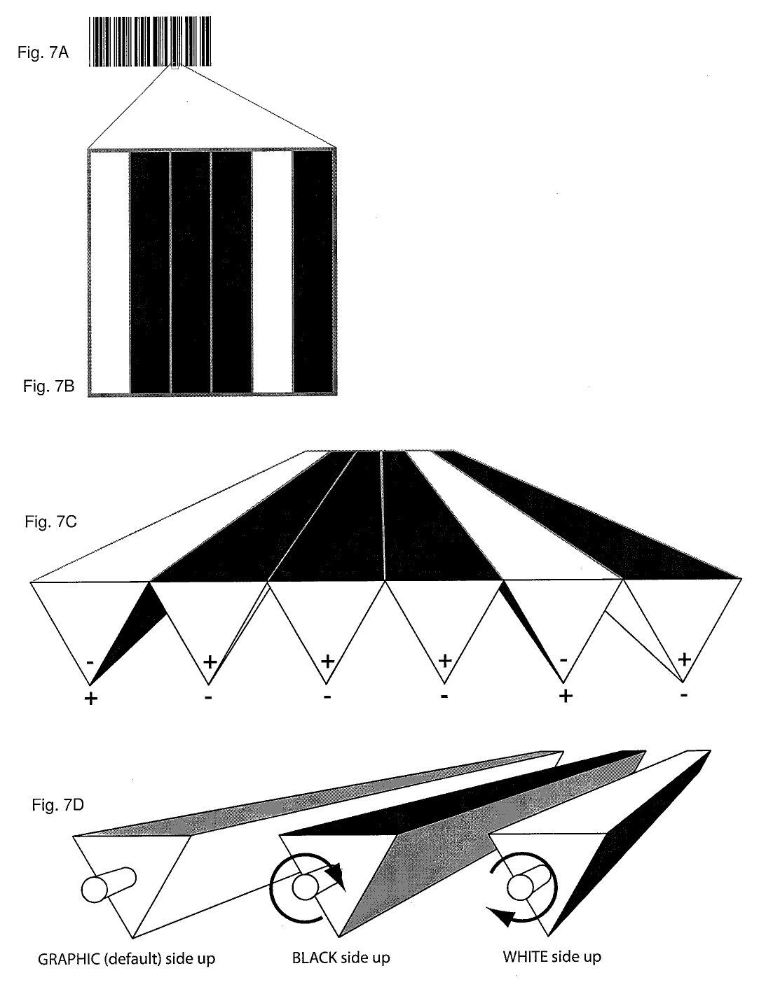

FIGS. 7A-7D further, illustrate the generation of a bar code by a rotating triangle technology that implements the invention of the plurality of elongated flat face bar code elements described above. As shown in FIGS. 7A-7D, this technology may be used to generate three views. FIG. 7A depicts a bar code display. FIG. 7B shows a close up view of a segment of the bar code. Each visible line is a separate triangular bar, which as shown in FIG. 7C is aligned in parallel with the other bars. Variable line thicknesses of a bar code may be achieved by having adjacent bars display the same color (e.g., white or black in sequence). FIG. 7D shows that each triangular bar can rotate to display one of three different panels: black, white and a third variable panel that may be part of a predetermined graphic (shown as gray in the figure). The triangular bars may rotate on a central axis that runs through each bar. A positive and negative charge may be used to rotate the bar and to hold it in the desired display sequence. Thus, if one vertex of post has a positive charge, that vertex will be attracted to a negative charge established by the device in its proximity. By separately controlling the negative, positive or neutral charges in the vicinity of one or both ends of each elongated bar code element the rotational position of the element can be controlled. Through the use of this technology, the bar code can be displayed without the use of a light emitting diode.

The device also comprises a computer program product. The computer program product is part of or stored within a processing unit that forms the hardware of the device. It comprises an executable set of commands that enable a user to select a tracking code and to display the tracking code in a desired or specified format, e.g., as a bar code within a display means.

The device also comprises a memory module. The memory module is configured to store a plurality of tracking codes. The computer program product is operably coupled to the memory module and to the display means.

In some embodiments, the computer program product enables the same display means to have a plurality of display modes. A first display mode may be configured to display an electronic (or digital) bar code. When in this mode, the device preferably displays one bar code at a time that corresponds to a consumer identification number. The computer program product may cause the display means to display the tracking code in a plurality of formats. When the device cycles through a plurality of bar code formats, in some embodiments, each bar code format is displayed between ¼ and ¾ of a second, more preferably between ⅓ and ⅔ of a second. Two competing goals determine the range of acceptable display times. On the one hand, a user wants the displays to be quick so that the transaction is not slowed down. On the other hand, the reader will need the image to be displayed long enough to be read.

Bar codes come in many formats, and most consumers have seen them used across many industries such as grocery or retail stores, as well as in healthcare, manufacturing, retail, etc. Unfortunately, there is no one standard set of bar code formats that have been adopted by all industries. Examples of bar codes technologies include but are not limited to UPC/EAN, Code 39, Code 128, Interleaved 2 of 5, Postnet, and PDF417. Each has a format that is recognized by persons of ordinary skill in the art.

In some embodiments, the bar code display is 1-D (one dimensional with each bar appearing as lines of different thickness and with different spacing between bars). In some embodiments, the bar code display is 2-D (two dimensional).

The bar codes of the present invention are capable of being read by optical scanners. Accordingly, the display of the bar codes should be in a format and within a technology that is capable of being read. When using computer generated bar codes, there are two primary variables to consider when designing a bar code reading system that relies on reading a computer generated and displayed bar code: (1) resolution; and (2) interference.

First, the computer screen must be of a resolution that is sufficient to generate a bar code that is readable if standard bar code dimensions are used. Persons of ordinary skill are aware of the types of displays that provide high resolution. However, the necessary resolution of the image will depend on the quality of the scanner. The scanner resolution is measured by the size of the dot of light emitted by the reader. If this dot of light is wider than any bar or space in the bar code, then it will overlap two elements (two spaces or two bars) and it may produce wrong output. On the other hand, if too small a dot of light is used, then it can misinterpret any spot on the bar code making the final output wrong. An exemplary dimension is 13 mils, which is a relatively high resolution, and it is preferable to have bar codes that are generated with a high resolution graphic application.

Second, light emitting display technologies that are often used in screens for laptop computers and cellular telephone are designed to be of sufficient power to operate in low light and to be seen from significant distances. In order to obtain these capabilities sufficiently powerful light waves are emitted. Most bar code readers are not able to read codes displayed on these types of screens because the light emitted from the screens interferes with the optical reader's technology. (Today's bar code readers such as pens and laser scanners measure the intensity of reflected light and therefore, cannot be used to read from a monitor because the glass or plastic in the monitor screen does not reflect light back to the reader.) Thus, unless the optical reader is configured to reduce the interfering signals sent by the emitting device, it is preferable to use alternative display technologies such as reflective display media.

As U.S. Pat. No. 6,704,133 describes: “There are a number of interesting reflective display media which provide good optical appearance and the ability to be easily constructed in large areas or on flexible substrates at low cost . . . . Suitable display media include microencapsulated electro-optic displays, electrochromic displays, rotating bichromal ball displays, suspended particle displays, and composites of liquid crystals with polymers, including polymer dispersed liquid crystals, polymer stabilized liquid crystals, and liquid crystal gels.” By way of example, rotating bichromal ball displays are described in U.S. Pat. No. 5,900,858 issued to Xerox.

As noted above, in some embodiments, the bar codes of the present invention that are displayed are comprised of a combination of characters or fonts that form lines or bars of different thickness or spacing. Thus, by way of example, the bar code may be formed by contrasting electronic media that displays lines or bars of different thickness and/or spacing.

A second display mode may show an index of bar codes. An index is a list of descriptions of the tracking codes that may be readily understood by a user. The index represents the names or identifiers of the vendors and service providers for whom tracking codes are stored. By way of example, the index may be an alphabetical listing of the descriptions of the bar codes. When a graphic user interface is the first display means and the elongated triangle elements are the second display means, then the device may be configured to have the second display mode appear within the first display means.

In some embodiments, the device may display six or fewer descriptions at a time when in the second display mode. Thus, it may display a subset of the total index at any one time. In some embodiments, the device may display five or fewer descriptions at a time when in the second display mode. In some embodiments, the device may display four or fewer descriptions at a time when in the second display mode. In some embodiments, the device may display three or fewer descriptions at a time when in the second display mode. In some embodiments, the device may display two or fewer descriptions at a time when in the second display mode. In some embodiments, the device may display one description at a time when in the second display mode. These descriptions may be referred to as “descriptors.” A user may review the descriptors in order to facilitate choosing a bar code and by selecting a descriptor, cause the device to display the bar code.

When displaying a bar code, the computer program product is preferably configured to display only one bar code at a time. Thus, the computer program product may comprise an executable set of commands that enable a user to review a list of descriptions of a plurality of electronic tracking codes and then to select the desired description, thereby causing the computer program product to display a bar code that is associated with the selected description. In some embodiments, the device and computer program product are designed such that either one or more descriptors are displayed or a bar code is displayed; however, in these embodiments the bar code and the descriptor are not displayed simultaneously. In other embodiments, there may be a single graphic user interface in which one portion (e.g. the top) displays the descriptors while the other portion displays the bar code (e.g., the bottom).

The device may be encased in a housing. The housing may for example, be made of plastic, metal, cushioned material or any combination thereof. The housing is preferably designed to protect the display means and the hardware on which the computer program product and memory module are stored. The housing may also be stored in whole or in part in a protective case for further protection.

The device may also comprise a first input mechanism. The first input mechanism may for example be a scrolling mechanism that enables a user to scroll through a list (e.g., a vertically displayed list) of the descriptors. Accordingly, if the descriptors are organized alphabetically, when the device is activated (i.e., turned on or transitioned from a sleep mode to an active mode) the first description in the list may be highlighted or otherwise denoted as being a description that the user may select. The computer program product may also be configured such that when a device moves from off to on or moves out of sleep mode, the last description selected rather than the first in an alphabetical list is the first description to be denoted as being a description that the user may select. The computer program product may also be configured so that when the last listing is reached and a user scrolls down, the first descriptor appears.

By depressing and releasing the first input mechanism the user may be able to scroll through the list of descriptions of consumer identifiers.

The device may also comprise a second input mechanism that enables the user to scroll through the list in the opposite direction from which the first input mechanism enables the user to scroll through the list. For example, if the first input mechanism enables a user to scroll through the list in alphabetical order, the second input mechanism may enable a user to scroll through the list in reverse alphabetical order. When there are both a first input mechanism and a second input mechanism they may for example, be located on the front of the device or on a side of the device or on opposite sides of the device.

The first and second input mechanisms may be of any shape, e.g., a circle, a square, a triangle or an arrow and may be comprised of any hardware or software that is now known or that comes to be known to persons of ordinary skill that may be useful for initiating action by a computer and computer program product such as that within the device of the present invention.

The device may also comprise an on/off input mechanism. The on/off input mechanism may for example, be a button that is located in the proximity of the first input mechanism. The on/off mechanism may also be located on the device in a location that is not in the proximity of the first input mechanism (and second input mechanism if present). For example, the device may have the display means, the first input mechanism and second input mechanism located on a first side, while an on/off mechanism is located on a second side. In some embodiments, the on/off input mechanism is a switch.

The device may also comprise a selector mechanism that is distinct from the first input mechanism that enables a user to select from the descriptions of the electronic tracking codes from within the list and thereby cause the device to display a selected electronic tracking code. When the device comprises a selector mechanism that is distinct from the first input mechanism, the first input mechanism may be configured such that an impulse from it will cause the user to scroll down the list, but in order to select a particular description for an electronic tracking code, the user will need to activate e.g., depress, the selector mechanism. When no distinct selector mechanism is present, the device may be configured such that holding the first input mechanism for more than a fixed period of time, e.g., more than two seconds, the device interprets the continued depression as an instruction to select the description that is highlighted. Each of the input mechanisms, selector mechanisms and on/off mechanisms, when present are operably coupled to the computer program product.

The device also comprises a memory module. The memory module is the part of the device that stores the tracking code and the descriptor that is associated with each tracking code. Typically the memory is stored in digital form.

Upon activation, the computer program product executes a series of commands that extracts an index of the descriptors that are stored within the memory module. A first descriptor or a first group of descriptors, e.g., three descriptors may be displayed. These descriptors may remain displayed until a user scrolls down the list and/or selects a particular descriptor. There may also be a default function so that if no selection is made after a fixed amount of time, e.g., 15 seconds, the device goes into hibernation or shuts off, thereby saving power. The power source may for example be a disposable or rechargeable battery.

The device may also comprise a communication portal. The communication portal is a component through which the device can receive and transmit data to and from a different computer. To make use of the communication portal the device may for example be able to be connected to a computer through a universal serial bus (“USB”) port.

For convenience, the device may also comprise a mechanism for attachment to a key ring. For example, the device may have a hole through which a metal key ring can be threaded. The metal key ring may itself have keys affixed to it, or it may be connected directly or indirectly to another key ring that has keys associated with it.

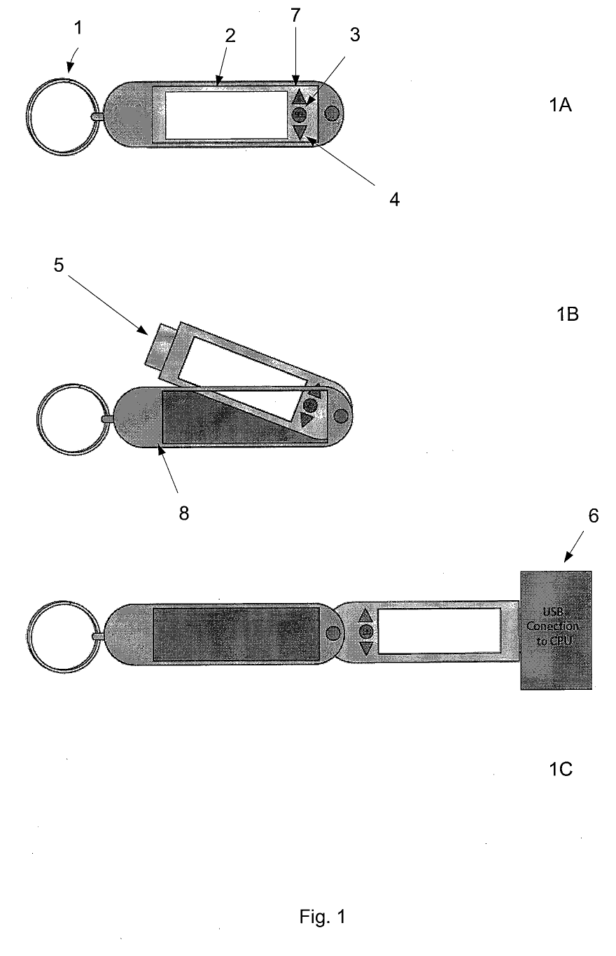

Examples of some of the aforementioned elements appear in FIGS. 1A-1C. FIG. 1A shows an apparatus with a key ring 1 and a display screen 2 that is not activated i.e., is turned off. Up 7 and down 4 arrows are also shown to enable a user to scroll up and down through a list of descriptors. Also shown is a select button 3 that may be present to enable a user to select a particular descriptor.

In FIG. 1B, the exemplary apparatus is shown rotated outside of its protective casing 8. In this view, a connector 5 for connection to a USB port is shown. FIG. 1C shows the apparatus as it is connected to a central processing unit (CPU) through a USB port.

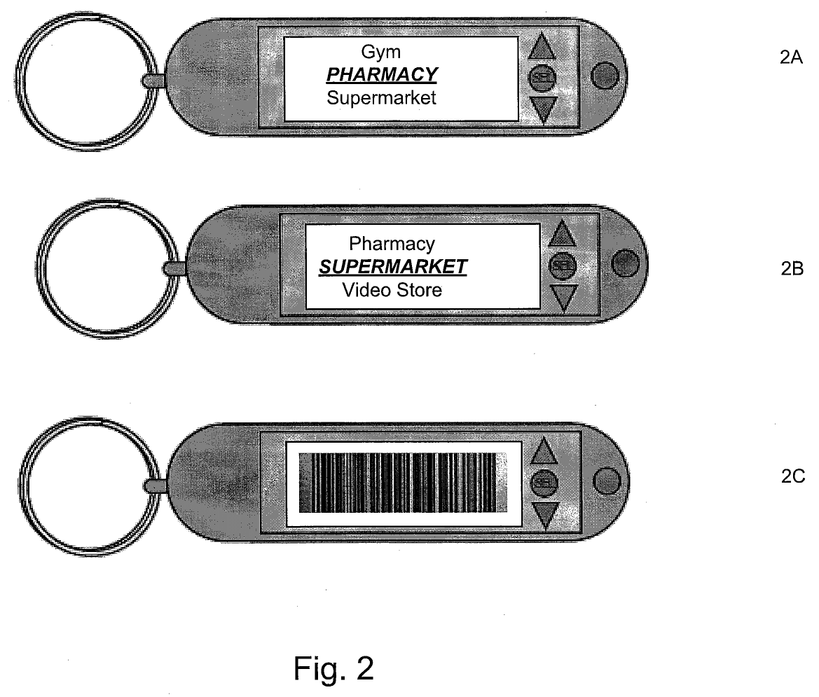

FIGS. 2A and 2B show the apparatus as activated and displaying sets of three descriptors. FIG. 2A shows the descriptors: Gym, PHARMACY and Supermarket. The bolding, underlining, italics and all caps in the figure denote that Pharmacy is currently in the select mode such that if the user were to depress the select button, the bar code for Pharmacy would be displayed. FIG. 2B shows the device after the user has pressed the down arrow to scroll downward from the set of descriptors as displayed in FIG. 2A to show Pharmacy, SUPERMARKET and Video Store. Whereas in FIG. 2A the term Pharmacy was in bold, italics, underline and all-caps, in FIG. 2B the term Supermarket is in bold, italics, underline and all-caps, thereby indicating that it is in position to be selected. FIG. 2C is a representation of a bar code as displayed on the device. The computer program product may be designed to display the bar code either with or without the digits that describe the code. In some embodiments, preferably when the bar code is displayed, it is displayed with either no other information or the only additional information is the digits that describe it.

As persons of ordinary skill know and as noted above, there are multiple formats for bar codes. In some embodiments, the computer program product further comprises a set of executable commands that are capable of displaying the tracking code in a plurality of bar code formats, e.g., two, three, four, five, six, etc. formats. This feature is particularly advantageous when one does not know which of the plurality of formats is to be used by an establishment. These formats may for example, differ with respect to width, height and/or spacing of the bars.

For many establishments, the bar code format is well known, and the computer program product may be configured such that for these codes, only the format that is known to be acceptable is displayed. Thus, associated with these tracking codes may be a code that directs the computer program product not to cycle through a plurality of bar codes but instead to display it in only one specified format. Alternatively, the tracking code for which cycling is to occur, may contain a code that directs the cycling and the default is no cycling and display in one format. The direction to cycle or to use a particular font may be stored with a tracking code or associated with a tracking code.

When the computer program product causes the cycling through and display of at least two formats, more preferably at least three formats, preferably the cycling through the complete set occurs in less than 2 seconds, more preferably less than 1.5 seconds and most preferably less than 1 second. In some embodiments, the computer program cycles through at least three bar code formats in less than 1 second. Preferably, the display means of the different formats occurs sequentially so that no two formats of a bar code are displayed at the same time.

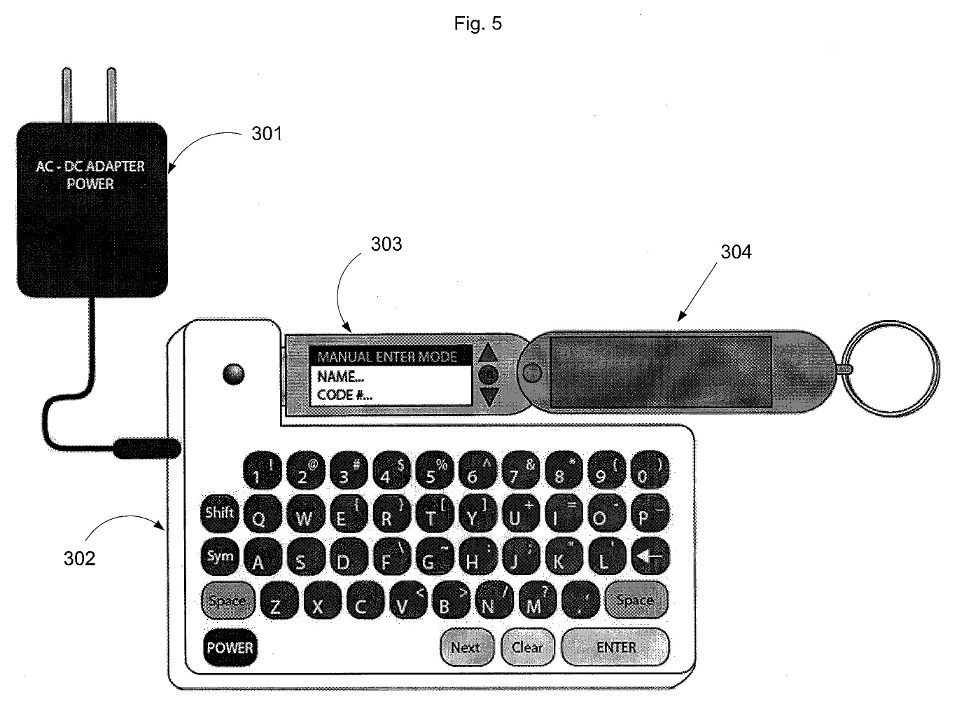

In some embodiments, the electronic device of the first embodiment may also be part of a system that comprises a standalone docking station. An exemplary standalone docking station as connected to an electronic device is shown in FIG. 5. The standalone docking station 302 may comprise a keyboard and a USB port through which the electronic device 303 may be connected. The term “standalone” means not connected to any network or the Internet and thus not in communication with any other system. The docking station may also have a means for connecting to a power supply such as through an AC-DC adaptor 301, or a battery, (e.g., a rechargeable battery, not shown) housed within the device. If a protective housing 304 is present, the device may be oriented to expose the USB port in order to provide access to the docking station. The same USB port could of course receive data from either the standalone docking station or a networked computer. The device may also contain a light display indicating via colors the level to which the battery is charged. The device may also contain a display indicating the amount of unused memory on the device.

Through this docking station, a user may type in her bar code and a descriptor, which would be stored directly on the device, and optionally on the standalone docking station if the standalone docking station has sufficient memory capabilities. The standalone apparatus may further comprise a screen. In embodiments in which the standalone docking station does not comprise a screen, a user may view what she inputs on the display screen of the device of the present embodiment. This data input view may be part of a third display mode that provides a means for a user to view what she inputs. The embodiment with a standalone docking station may be particularly desirable for persons who either do not have access to the Internet or other network, or who choose not to access those networks.

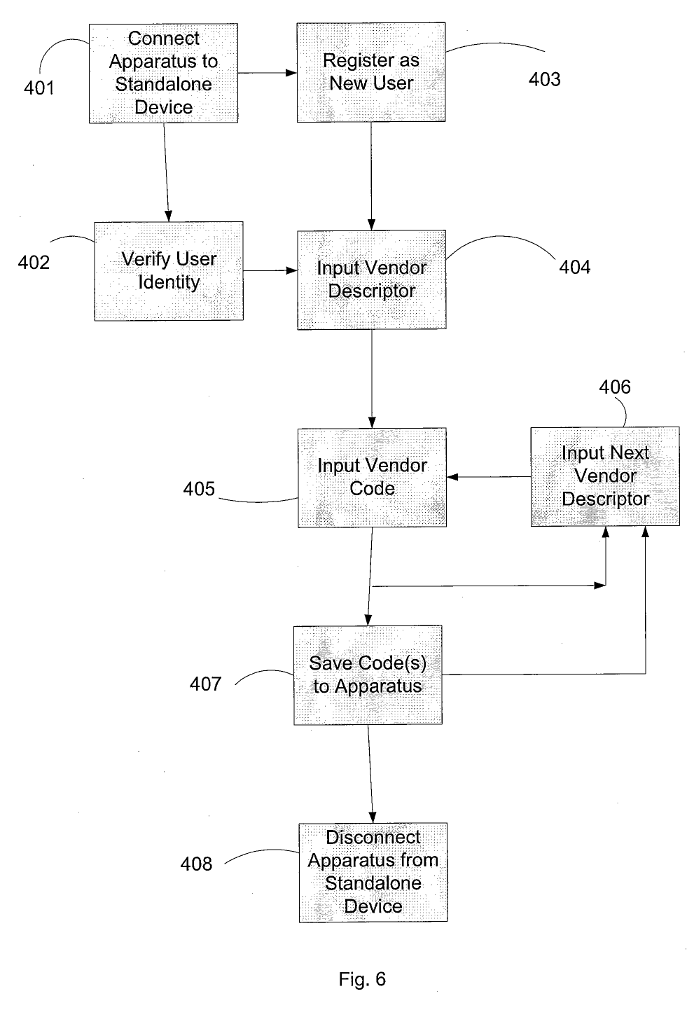

A flowchart depicting the method for using the standalone device may be seen in FIG. 6. A user connects her apparatus to the standalone device 401. She may register as a new user 403, and initialize her device if necessary. Although the standalone device is not connected to a network, it may be advantageous, though is not necessary, to have the individual register on the standalone device so that her tracking codes can be stored in its memory, and/or to enable privacy to be retained if a plurality of users have access to the same device. If she has previously used the device, she may verify her identity 402 through for example the use of a password.

After the user has successfully connected to the standalone device, she may input the vendor descriptor 404 followed by the vendor code 405. The user may then save the code to the device, 407, or input another vendor descriptor 406 and vendor code 405, prior to saving on the apparatus and disconnecting from the standalone device 408. By way of example, a user may have information presented in a physical coupon or on an already issued plastic card with a tracking code. She may then input this information through the standalone device.

According to another embodiment, the present invention is directed to a method of accessing a tracking code for display and detection. This method comprises: (1) activating a device; (2) selecting a tracking code that is stored in the device; and (3) presenting the device to a detection apparatus.

In some embodiments, the device comprises (i) a display means; (ii) a computer program product, wherein the computer program product comprises an executable set of commands that enable a user to select a tracking code and to display the tracking code within the display means; and (iii) an electronic memory module, wherein the electronic memory module is configured to store a plurality of electronic tracking codes.

By selecting a tracking code from within the plurality of tracking codes a user causes the electronic tracking code to be displayed. The consumer may then present the device to a detection apparatus.

In some embodiments, the electronic tracking code is displayed in the format of a bar code. As noted above, one may display the tracking code in a plurality of bar code formats in succession thereby cycling through these formats. The computer program product can be designed to cycle through the displays any number of times e.g. 2-20, 5-15, 8-12. Also, as noted above, prior to selecting the tracking code, a user may scroll through a list of descriptions of the plurality of tracking codes.

In some embodiments, the detection apparatus is an optical scanner. As persons of ordinary skill in the art are aware, optical scanners are designed to scan bar codes in any format that does not interfere with the reading capabilities. Thus, because the present invention may be used with non-reflective media that does not interfere with the reading capability of scanners, known optical readers may be used in connection with present device.

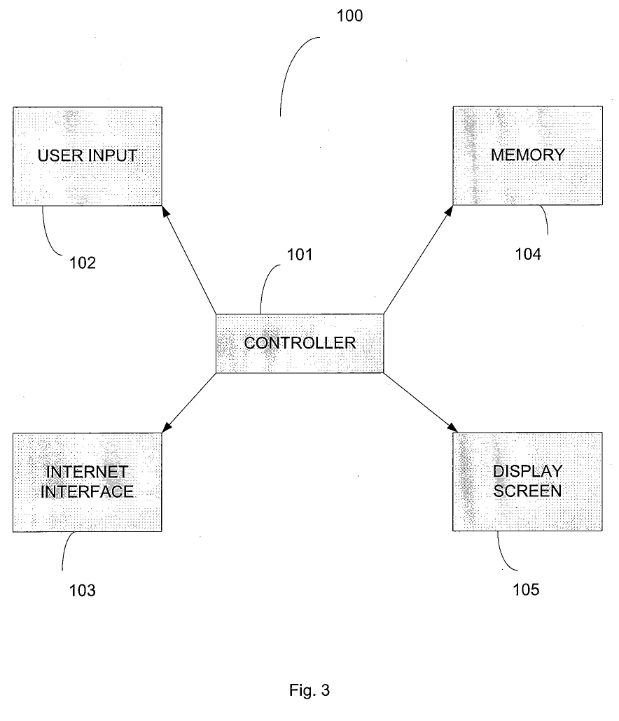

FIG. 3 illustrates a functional block diagram of an embodiment of an electronic control device of the present invention. The functional components of this embodiment of the device 100 include a controller 101, a user input functionality 102, an Internet interface functionality 103, a memory module 104 and a display screen 105.

The controller 101 controls the operation of the device. Thus, it controls the various functional blocks and is operably coupled to each of them. Through the Internet interface 103, the device communicates with an external data source. This may for example, physically be done through a USB port or through any other appropriate connection or wireless communication that would be useful in connection with the present invention. The external data source provides a consumer identification number and vendor descriptor to the device.

When the Internet interface is in communication with the controller it may through the controller direct storage in the memory 104 of the device. The memory stores the information of both the numeric code or alphanumeric code and a descriptor for each code. As described more fully below, it may also store a timing code, and directions as to whether to scroll through a plurality of bar code functions when activated.

When the user wishes to access a code, she tells the device through the user input function 102, which as noted above may, for example, be a mechanism that the user pushes to direct turning the device on and off, as well as scrolling through the descriptors. This input instruction is sent through the controller 101, which accesses the information from the memory module 104, retrieves the information and then sends it to the display screen 105.

If the apparatus is appropriately designed, through the user input 102, the user may direct scrolling of the index of codes stored on the device, and the controller 101 may cause the display screen 105 to display a different set of descriptors by moving up or down the list alphabetically. If the display screen shows three descriptors at a time, after receiving the direction to scroll, depending on how the computer program stored in the device is configured, the display screen, may for example remove the first alphabetic entry at the top of the list, and replace it with the next entry that is not currently being displayed at the bottom of the list, thereby causing the other two entries to move up in the field of view.

Once the user, through the user input 102 directs the controller 101 to select a particular descriptor, the controller may direct the display screen 105 to display the corresponding bar code in one or more formats.

According to another embodiment, the present invention is directed to a method for providing a user with a tracking code for display on a device. A first step of the method comprises saving a tracking code on a device. In some embodiments, the device may comprise a display means, a computer program product, and an electronic memory module. Preferably, the computer program product comprises an executable set of commands that enable a user to select a tracking code and to display the tracking code within the display means; and an electronic memory module, wherein the electronic memory module is configured to store a plurality of tracking codes.

In some embodiments, the computer program product is configured to display the tracking code as a bar code. As noted above, bar codes may be presented in a plurality of formats, and in some methods, the device cycles through a plurality of bar codes, presenting them one at a time. In embodiments in which the computer program product cycles through a plurality of formats when displaying bar codes, the computer program product within the device may be designed to cycle through a plurality of bar code formats for any electronic tracking codes that is selected or for less than all. For example, if the particular format of a vendor is known, within the memory of the device may be stored an instruction to display the electronic tracking code as a bar code in only one specified format. Thus, in some embodiments, it cycles through a plurality of bar code formats for some tracking codes, but only displays one bar code format for other tracking codes.

In some embodiments, the method further comprises receiving the tracking code from the user or another source prior to saving the tracking code on the device. This receiving may, for example, occur through transmission over the Internet by accessing a URL or a local area network (LAN), or from a standalone computer.

The method may also comprise receiving and storing a user identifier, an email address and user password at a location remote from the device. The user may be contacted through this email address about up-coming promotions.

The method may also permit a user to input a description of the tracking code and the tracking code itself through e.g., a keyboard. The tracking code may be in a form selected from the group consisting of numbers, letters, characters and combination thereof.

The method may also comprise the user transmitting the description and the tracking code over the Internet to a remote location prior to saving it on the device. Thus, if the user already has a bar code on plastic cards, she need not obtain new codes to use the present invention.

One may also verify the format of the tracking code, and/or format the tracking code as an electronic tracking code. If the user has a bar code on a plastic card, she may examine a plurality of bar code formats on a web-site and select the one that is the format of her issued bar code and then have the format information stored on her device. This will enable her to use the present invention for that bar code without cycling through a plurality of bar codes when presenting it.

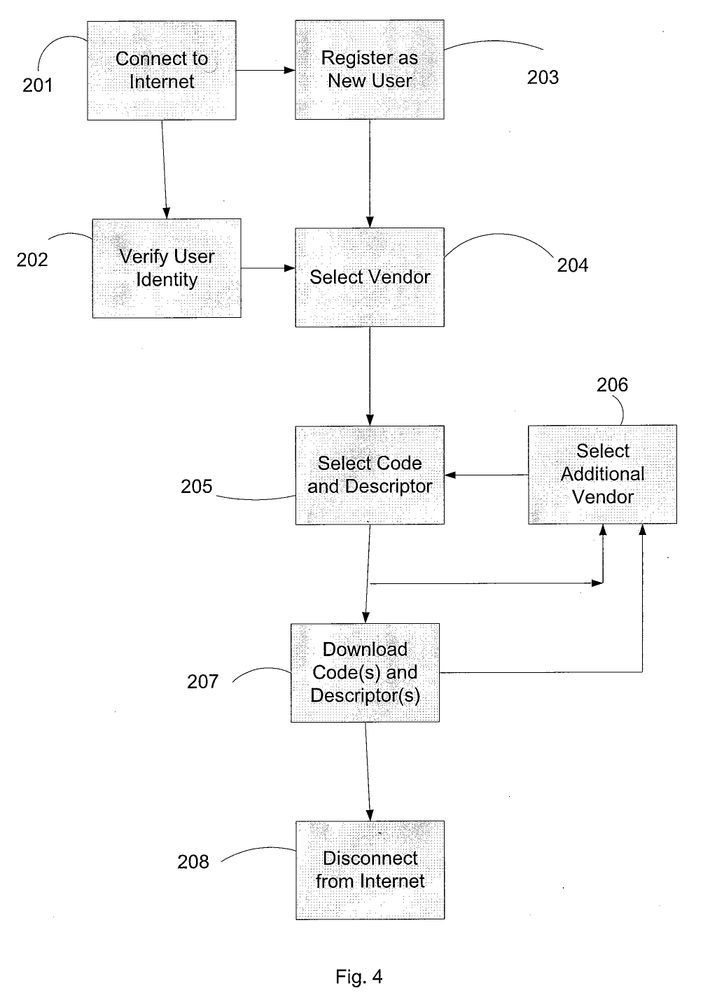

An exemplary method and system of the present invention may be illustrated by reference to FIG. 4. According this method a user may connect her apparatus for displaying tracking codes to the Internet 201, through for example a USB port. The connection may occur at any location, including but not limited to a person's home or place of employment. By way of further example, it may occur at a location at which the user acquires the apparatus, such as a retail store or service provider.

After connecting to the Internet, if the user is a new user, she may register 203 or if she is already a user of the service, verify her identity 202. There is no limit to the amount or type of information that may be requested in a user profile. For example, any combination of the following types of information may be included: name, age, gender, address, telephone number, email address, marital status, income, leisure activities, status with respect to children, profession, etc. The system may be designed to make any or all of this information optional or mandatory. Because many consumers are guarded about their privacy, in many embodiments it is advantageous to request only a minimal amount of information, for example, user name, user password and user email.

After either registering as a new user or verifying an identity, a user may select a vendor 204. This may be done either by going to a specific vendor's web-site or through a separate web-site that provides access to one or more tracking codes. This latter web-site may be the same as the log on site or accessed through a hyperlink.

If the user visits a web-site that contains a plurality of vendors and service providers for which to download user identification codes, she may request a download of a code and a descriptor 205 then either select additional vendors 206 or proceed directly to a step of downloading the code and descriptors 207 to her apparatus, which would then be stored on the apparatus. The user may select and download codes one at a time or select a plurality of vendors' codes to be downloaded together.

Prior to downloading a descriptor and a code, a user may have the option to edit the descriptor. For example, if a particular descriptor's default name is “Gym” a user may be permitted to specify the name of her facility.

Additionally and as noted above, the user may be provided with the option of inputting information for an electronic tracking code. This will be useful when a user has already been issued a physical bar code with a tracking number and the user does not wish to have a new number assigned. In these circumstances, the user may type in the numerical identifier that is printed on her physical card into an input field on the web-site. The user may also type an appropriate descriptor.

After the user completes the process of downloading the desired set(s) of codes, she may disconnect from the Internet 208. In some methods and systems, in addition to having a descriptor associated with each bar code, there may be data associated with it that delineates in which format the electronic code should be displayed or if the format is not known, then when the electronic code is displayed, it should be displayed in plurality of formats in succession, e.g., at least two, at least three, at least four, at least five, at least six, etc. If the bar code format that a system can read is known, then the user may elect to store the tracking code with information that indicates in which format to display the bar code.

According to another embodiment, the present invention provides a method for facilitating consumer transactions. The method comprises: (a) storing a first tracking code and a first identifier on a device, wherein the device is capable of displaying the first tracking code as a first bar code and capable displaying the first identifier; (b) storing a second tracking code on the device, wherein the device is capable of displaying the second tracking code as a second bar code, wherein the second tracking code is associated with an expiration code, wherein the expiration code defines a period of time; and (c) selecting the first identifier, thereby causing the device to display the second bar code if the first identifier is selected within the period of time, and if the first identifier is selected not within the period of time, then displaying the first bar code. The expiration code may be one or more digits or characters within the second tracking code so that it is represented in the bar code that is ultimately displayed or it may be a code that does not form part of the bar code that is ultimately displayed.

An exemplary device that may be used in connection with this embodiment comprises: (a) a display means; (b) a computer program product, wherein the computer program product comprises an executable set of commands that enable a user (i) to select a tracking code (ii) to display the tracking code within the display means in a plurality of bar code formats; (c) an electronic memory module, wherein the electronic memory module is configured to store a plurality of tracking codes; and (d) a time module, wherein the time module is capable of tracking the elapsing of time. The information may, for example, be input through downloading of the tracking codes and identifier over the Internet.

This methodology is particularly advantageous for providing sale coupons to consumers. For example, a first vendor may issue a tracking code (also referred to as a user identification number) to a consumer, referred to as the first tracking code above. This number may be stored on the user's personal device with her user identification numbers for other vendors as described above.

The first vendor may have a promotion on a particular type of goods or all goods for a fixed amount of time. The vendor may advertise this promotion in the traditional mass media or through email distributions to targeted customers or all customers in its database.

A consumer may access this promotion by retrieving a second tracking code. This code may for example be obtained by accessing an appropriate database on a web-site or inputting it through the standalone device described above. If the user is enticed to visit a web-site, the vendor has an additional opportunity to market to her.

The second tracking code will preferably contain or be associated with an electronic tag or other demarcation that enables the device to note that the second consumer code is a temporary code that is to be associated with the same descriptor as the first consumer code. The code may contain a life span notation that indicates that the code is to be used for a fixed amount of time, e.g., for twenty-four hours, one week, two weeks, etc. Alternatively (or additionally) the code may contain a code that indicates a stop date, e.g., October 1 of a particular year. The code may also contain a start date, e.g., September 28, of a particular year. There can also be a default that the code is to be active from the time that it is installed on the device until the stop date.

When the user operates her device, if it is during the duration of useful life of the second tracking code then upon selecting the first descriptor, the second code will be displayed. If the first descriptor is selected prior to or after the useful life, then the first code will be displayed.

In order to determine whether to apply the first tracking code or the second tracking code, the device will have a method for tracking time. The device will also have a computer or module that upon activation and selection of a descriptor will search for whether there is one or a plurality of consumer codes associated with that descriptor. If there are a plurality of codes then the computer program module will enter a simple algorithm to determine which consumer code to display based on the information in the time tracking module.

In some embodiments the descriptors for which there are a plurality of codes may have an asterisk or other modification to denote that a sale code is stored in the device, and/or the window for using the sale code is open.

This embodiment of the present invention is of particular interest to vendors who track their consumers' purchases. For example, if a supermarket tracks a user's purchases and notices that she purchases diapers, the supermarket may send the user notifications to download a consumer code that provides discounts for products needed when raising small children. As time progresses and the consumer no longer purchases diapers, the supermarket may send notifications of sales on items typically purchased by parents of pre-school and elementary school children.

The apparatuses, methods and systems of the present invention may also be of use in combination with service industries that issue tickets to patrons. For example, a user could purchase a ticket over the Internet from a vendor that enables the user to gain admission to a place or an event. These places or events include but are not limited to sporting events, theater events, amusement parks, museums, beaches, trains, subways, boats, airports, etc.

For these types of service industries there are known applications through which a user can purchase a ticket on-line, by for example, inputting her credit card number. In one known application, the user can print a paper copy of the receipt that contains the bar code on it. The printout serves as the ticket to be scanned by an optical scanner at the site of the event. In another embodiment, the user is not sent a bar code for printing, and instead after giving her credit card number to the vendor (or otherwise authorizing the purchase), a ticket is placed “on hold” and at the site of the event or at the location that the user wishes to enter or to which she seeks to enter. The user then swipes her credit card through a credit card reader at a kiosk or other terminal to obtain the ticket.

Neither of these methods is optimally efficient. The first requires the user to print out and to carry an extra piece of paper, and the second requires the user to swipe her credit card prior to entering an event.

A more efficient system can be implemented using the present invention. For example, a user may purchase admission to an event or place by requesting admission through an on-line vendor. Prior to, or after making the request, the user may put her electronic device for displaying a tracking code in communication with the network. After the transaction is complete, the network will transfer to the device both a code that may be displayed as for example, a bar code in one or more formats as described above, as well as a descriptor that facilitates a user's ability to access the bar code. The descriptor may be loaded so that it is incorporated into the index that is displayed when the device is in use and the device is in the applicable display mode. As in the embodiments described above, the descriptor is operably coupled the code that is loaded onto the device with it.

The bar code may be representative of the event or location to which access is desired, as well as the date and time for which admission has been purchased, and the number of tickets purchased. The code may also have an expiration notation that causes it to become inactive or to be deleted after a fixed amount of time such that the descriptor is not within the index of descriptors through which a user may scroll.

As described above in other embodiments, the user may present the device to an optical reader at the site. The reader may be operably connected to (or comprise) a processor that is connected to a printer and thereby printout a paper ticket for the user. Alternatively or additionally, the reader could be operably coupled to a turnstile or other device for physically prohibiting a person who is not a patron from entering, and direct release of the locking mechanism that prevents the turnstile from turning when a proper barcode is presented. If the barcode is representative of a code that indicates that a plurality of tickets, e.g., two, three, four, five, six, etc. have been purchased, then the turnstile would be unlocked to permit the number of persons to enter for whom tickets have been purchased. Still further or alternatively, the reader could be operably connected to (or comprise) a display that indicates that a bar code has been read and that the bar code provided authorization for admission. The display that is operably connected to (or comprises a part of) the reader may be configured to show that one or more tickets have or have been purchased by the user of the device, e.g., the reader's display may be capable of displaying a red or green light, and/or symbols or words that reveal the contents of the code, e.g., the number of tickets that were purchased and/or the event for which they were purchased.

This application discusses specific embodiments of the present invention. The specific features described herein may be used in some embodiments, but not in others, without departing from the spirit and scope of the invention as set forth in the foregoing disclosure. It will be appreciated by those of ordinary skill in the art that the illustrative examples do not define the metes and bounds of the invention. For example, the present invention should not be limited by software/program, computing environment, or specific computing hardware.

We claim:

1. An electronic device for displaying a tracking code, said device comprising:
a. a display means;
b. a computer program product, wherein said computer program product comprises an executable set of commands that enable a user
i. to select a tracking code, and
ii. to display said tracking code within said display means in a plurality of bar code formats; and
c. an electronic memory module, wherein said electronic memory module is configured to store a plurality of tracking codes, and said electronic memory module is operably coupled to said computer program product.

2. The device of claim 1, wherein said display means is capable of displaying said bar code through non-reflective display media.

3. The device of claim 1, wherein said plurality of tracking codes represent numerical codes.

4. The device of claim 3, wherein said computer program product is configured to display one bar code at a time.

5. The device of claim 1, wherein said computer program product further comprises an executable set of commands that enable said user to review a list of descriptions of said plurality of electronic tracking codes.

6. The device of claim 5 further comprising a first input mechanism, wherein said user may use said first input mechanism to scroll through said list.

7. The device of claim 6 further comprising a second input mechanism, wherein said first input mechanism enables said user to scroll through said list in a first direction and said second input mechanism enables said user to scroll through said list in a second direction.

8. The device of claim 7 further comprising a selection mechanism, wherein said selection mechanism enables said user to select from said descriptions of said tracking codes from within said list and thereby cause said device to display a selected tracking code as a bar code.

9. The device of claim 1 further comprising a mechanism for connecting said device to a computer and said mechanism for connecting said device to said computer comprises a universal serial bus port.

10. The device of claim 1, wherein said computer program product further comprises a time keeping module.

11. A method of accessing a tracking code for display and detection, said method comprising:
a. activating a device, wherein said device comprises
i. a display means,
ii. a computer program product, wherein said computer program product comprises an executable set of commands that enable a user
1. to select a tracking code and
2. to display said tracking code within said display; and
iii. an electronic memory module, wherein said electronic memory module is configured to store a plurality of tracking codes,
b. selecting a tracking code from said plurality of tracking codes thereby causing said tracking code to be displayed as a bar code; and
c. presenting said device to a detection apparatus and displaying said tracking code in a plurality of bar code formats.

12. The method of claim 11, wherein prior to selecting said tracking code, said user scrolls through a list of descriptions of said plurality of tracking codes.

13. A method for providing a user with a tracking code for display on an electronic device, said method comprising saving a tracking code on a device, wherein said device comprises:
a. a display means;
b. a computer program product, wherein said computer program product comprises an executable set of commands that enable a user
i. to select a tracking code, and
ii. to display said tracking code within said display means; and
c. an electronic memory module, wherein said electronic memory module is configured to store a plurality of tracking codes and is operably coupled to said computer program product.

14. The method according to claim 13, wherein said computer program product is configured to display said tracking code as a bar code.

15. The method according to claim 14, wherein said device is configured to display one bar code at a time.

16. The method according to claim 13 further comprising receiving said tracking code from said user prior to saving said electronic tracking code on said device.

17. The method according to claim 16, wherein said receiving occurs through transmission over the Internet.

18. A method for facilitating consumer transactions, said method comprising:
a. storing a first tracking code and a first identifier on a device, wherein said device is capable of displaying said first tracking code as a first bar code and capable displaying said first identifier;
b. storing a second tracking code on said device, wherein said device is capable of displaying said second tracking code as a second bar code, wherein said second tracking code comprises or is associated with an expiration code, wherein said expiration code defines a period of time; and
c. selecting said first identifier, thereby causing said device to display said second bar code if said first identifier is selected within said period of time, and if said first identifier is selected not within said period of time, then displaying said first bar code.

19. The method according to claim 19, wherein said device comprises:
a. a display means;
b. a computer program product, wherein said computer program product comprises an executable set of commands that enable a user
i. to select a tracking code, and
ii. to display said electronic tracking code within said display means in a plurality of bar code formats;
c. an electronic memory module, wherein said electronic memory module is configured to store a plurality of tracking codes; and
d. a time module, wherein said time module is capable of tracking the elapsing of time.

20. A device for displaying bar codes, wherein said device comprises:
a. a plurality of bar code elements, wherein each bar code element comprises a first elongated flat face, a second elongated flat face and a third elongated flat face, wherein said first elongated flat face is colored with a first color and said second elongated flat face is colored with a second color, wherein said first color and said second color are not the same color and wherein each of said bar code elements may rotate along an elongated axis; and
b. a mechanism for controlling the position of each of said bar code elements around its axis.
